(19) United States
(12) Patent Application Publication
(10) Pub. No.: US 2026/0242143 A1
(43) Pub. Date: Aug. 20, 2026

(54) DECOUPLED AND MODULAR MULTI CHANNEL ORDER FULFILLMENT SYSTEM WITH CONTROL SYSTEM ADAPTABLE FOR DEMAND-DRIVEN FLEXIBILITY AND PRODUCTIVITY

(71) Applicant: Dematic Corp., Grand Rapids, MI (US)

(72) Inventors: Dan Moreno, Newnan, GA (US); Ryan Kirklewski, Waukesha, WI (US); Debarghya Bhandary, Columbus, GA (US); Francisco Arzu, Austin, TX (US); Arturo Hinojosa, Austin, TX (US); Ozge C. Sayilar, Austin, TX (US); David McCauley, Caledonia, MI (US)

(21) Appl. No.: 19/161,564

(22) PCT Filed: Mar. 1, 2024
(86) PCT No.: PCT/IB2024/052031

§ 371 Date: Sep. 2, 2025

Related U.S. Application Data
(60) Provisional application No. 63/488,263, filed on Mar. 3, 2023.

(51) Int. Cl. B65G 1/137; G06Q 10/087

(52) U.S. Cl. CPC B65G 1/1378; G06Q 10/0874

(57) ABSTRACT

An order-fulfillment system for a warehouse in accordance with the present invention includes a control system (301), a memory (306), a modular inventory storage system (312), and reconfigurable workstations (352). The control system (301) controls fulfillment activities of the warehouse (300), manages the configuration of workstations (352) for order fulfillment, inventory induction, or order packing, and records operational data (294) corresponding to the fulfillment activities in the warehouse (300). The control system (301) comprises a plurality of workflows selected from a library of workflows (304) stored in the memory (306). The memory (306) holds operational data (294). The selected workflows and a configuration of the modular inventory storage system (312) correspond to the current state of the warehouse (301) defined by selected portions of the operational data (294) and expected demands.

### FIELD OF THE INVENTION

The present invention is directed to a configurable order fulfillment and control system in a warehouse environment, and in particular to dynamically managing the warehouse environment and the order fulfillment process during changing demand needs by providing a decoupled and modular fulfillment system.

### BACKGROUND OF THE INVENTION

The control of an order fulfillment system within a warehouse facility with a variety of workers or agents (e.g., human pickers, robotic pickers, item carrying vehicles, conveyors, and other components of the order picking system) is a complex task. Conventional control methods are used to seek various objectives in an ever-increasingly complex order fulfillment environment characterized by scale of SKU variety, order composition ranging from single SKU to multiple SKUs, widely varying order demand in magnitude and time scales coupled with the very demanding constriction of delivery deadline. This complexity is further compounded as conventional warehouse environments traditionally rely on “set in stone” automated and manual hardware and processes where the warehouse environment may be able to handle current day-to-day order fulfillment operations but are locked down in turns of upgradability and flexibility in the face of rapidly changing demands and needs.

### SUMMARY OF THE INVENTION

Embodiments of the present invention provide methods and a system for a decoupled and modular order-fulfillment system with intelligently orchestrated and dynamic workflows for demand-driven flexibility and productivity. Such order-fulfillment systems may be utilized in a variety of different environments, e.g., an e-commerce fulfillment center, a warehouse, and a micro-fulfillment center. Exemplary embodiments are configured to dynamically change how orders are fulfilled in/near real-time based on, for example, customer demands, available resources, and resource optimization via intelligent orchestration to flexibly adapt a dynamic reconfigurable physical infrastructure and associated workflows in response to changing needs. Such dynamic reconfigurability includes, for example, flexibly adding or reducing order fulfillment capacity (e.g., reconfigurable workstations, additional inventory storage, human or robot workers, and flexible automation and control solutions) temporarily or permanently, and adapting the capabilities over time allowing for flexible modular up/down-scaling. An exemplary embodiment and method for multi-channel order-fulfillment includes a combination of fixed automation, flexible mobile automation, and modular process/control systems. Exemplary fixed automation includes automated storage and retrieval systems (AS/RS storage systems) and unit sortation systems (e.g., cross-belt sorter, sorting mezzanines, and Bombay-style sorters). Exemplary mobile automation includes bin transportation by Autonomous Mobile Robots (AMRs), for example, bin-to-person AMRs, sortation inventory routing AMRs, and customer designated solutions (e.g., shelf-to-person AMRs). Exemplary modular process/control systems include a dynamically reconfigurable warehouse controller, control system, or orchestrator, a fulfillment control and monitoring system, a warehouse management system (WMS), a warehouse execution system (WES), and a supply chain management system.

An order-fulfillment system for a warehouse in accordance with the present invention includes a control system, memory, a modular inventory storage system, and reconfigurable workstations that may be operationally reconfigured, with the control system operable to revise fulfillment operations using the altered system without having to be re-programmed. The control system controls fulfillment activities of the warehouse, manages the configuration of workstations for order fulfillment, inventory induction, or order packing operations, and records operational data corresponding to the fulfillment activities in the warehouse. The control system comprises a plurality of workflows selected from a workflow library. The memory holds operational data. The selected workflows and a configuration of the modular inventory storage system correspond to the current state of the warehouse defined by selected portions of the operational data.

A method for controlling order-fulfillment activities in a warehouse in accordance with an embodiment of the present invention includes controlling fulfillment activities in the warehouse. The method includes managing the configuration of workstations for order fulfillment, inventory induction, or order packing operations. The configuration of a modular inventory storage system is also controlled. The method includes recording operational data corresponding to the fulfillment activities in the warehouse. The operational data is held in memory. The control of the fulfillment activities in the warehouse and the configuration of storage systems are defined by a plurality of selected workflows that are selected from a workflow library. The selection of workflows and the configuration of the modular inventory storage system correspond to the current state of the warehouse defined by selected portions of the operation data and expected demands.

In an aspect of the present invention, the order-fulfillment system includes a unit sortation system that includes a plurality of autonomous mobile robots (AMRs), each configured to move inventory items from one location to a desired next location.

In another aspect of the present invention, the modular inventory storage system includes one or more different storage techniques. A particular storage technique may either add or remove additional storage modules to the modular inventory storage system or add or remove additional storage resources to a module of the modular inventory storage system according to current or expected demands.

In a further aspect of the present invention, a workflow control module includes one or more function calls, with each function call a microservice.

In another aspect of the present invention, the reconfigurable workstations are configured to perform one of the following operations: order fulfillment, inventory induction, or order packing operations. The reconfigurable workstations will also be configured for use by humans and/or robots.

In a further aspect of the present invention, the control system is capable of determining or identifying a priority level of a newly received order. Inventory allocated for one or more previously received orders may be reallocated to the newly received order if necessary to meet the newly received order's customer service level agreement (“SLA”) if the newly received order has a priority level higher than the previously received orders.

The present invention thus provides an adaptable system and method for order-fulfillment activities within a warehouse facility that is configured to dynamically adapt to current operational conditions and/or expected demands. Through the use of modular storage systems, reconfigurable workstations, and control systems using selectable workflow control modules selected from a workflow control module library, the order-fulfillment activities may adapt to those changing conditions in real-time or near real-time. Such adaptations include dynamically increasing or decreasing inventory storage space, reconfiguring workstations to perform a selected order fulfillment activity or inventory induction/decant operation, and updating the selected workflow control modules selected from the workflow control module library. These and other objects, advantages, purposes and features of the present invention will become apparent upon review of the following specification in conjunction with the drawings.

### BRIEF DESCRIPTION OF THE DRAWINGS

FIG. 1A is a schematic overhead plan view of an exemplary configurable order fulfilment and control system in accordance with the present invention;

FIG. 1B is a block diagram of an exemplary aspect of a fulfillment/warehouse facility employing the control system in accordance with the present invention;

FIG. 2 is a block diagram illustrating the components of an exemplary order fulfillment system for use in a warehouse facility in accordance with aspects of the present invention;

FIG. 2A is a block diagram illustrating the operational and control components of an exemplary order fulfillment system;

FIG. 2B is a block diagram illustrating the components of another exemplary order fulfillment system for use in a warehouse facility in accordance with the present invention;

FIG. 3 is a block diagram illustrating the components of an exemplary order-fulfillment system and methods of an associated control system in accordance with the present invention;

FIG. 4 is a block diagram illustrating the architecture of an exemplary order-fulfillment system in accordance with the present invention;

FIG. 5 is a perspective view of an exemplary storage system of an order fulfillment system in accordance with the present invention;

FIGS. 6A and 6B are flow diagrams illustrating the steps of a method for controlling the operations of an exemplary induction/goods-to-person (GTP) workstation of an order fulfillment system in accordance with the present invention;

FIG. 7 is a flow diagram illustrating the steps of a method for pick verification at a workstation of an order fulfillment system in accordance with the present invention;

FIG. 8A is a block diagram illustrating the functional control steps of a task to be executed in an order fulfillment system in accordance with the present invention;

FIG. 8B is a block diagram illustrating the functional control steps of another task to be executed in an order fulfillment system in accordance with the present invention;

FIG. 9 is a flow diagram illustrating the steps of a method for reallocating inventory from one order to another based on order priority level in accordance with the present invention; and

FIG. 10 is a schematic illustration of a user interface for a control system in accordance with the present invention.

### DESCRIPTION OF THE PREFERRED EMBODIMENTS

The present invention will now be described with reference to the accompanying figures, wherein numbered elements in the following written description correspond to like-numbered elements in the figures. While conventional warehouse environments (e.g., order fulfillment systems) traditionally rely on “set in stone” automated and manual hardware and processes in which various components or sub-systems are configured for particular dedicated operations and are not adjustable, the exemplary order fulfillment and control system is configured to provide adaptive operational capabilities to avoid such “set in stone” features. Embodiments of the present invention provide methods and a system for a decoupled and modular order-fulfillment facility with intelligently orchestrated and dynamic workflows for demand-driven flexibility and productivity. Exemplary embodiments are configured to dynamically change how orders are fulfilled in/near real-time based on, for example, customer demands and resource optimization via intelligent orchestration to flexibly adapt flexible physical infrastructure and dynamic reconfigurable workflows in response to changing needs. An exemplary facility includes reconfigurable subsystems, which are substantially automated and multi-functional for item storage, carton erection, receiving, picking, inducting/decanting, sorting, consolidation, and packing. These various subsystems are directed to, but not limited to, item storage, receiving, decanting/induction, picking, sorting, packing trailer yard control, and carton erection. Such dynamic reconfigurability includes flexibly adding or reducing order fulfillment capacity (e.g., reconfigurable multi-purpose workstations (e.g., picking, decanting/induction, and/or packing), adding/decreasing inventory storage to a modular storage system, human or robot workers, and flexible automation solutions) temporarily or permanently, and adapting the capabilities over time allowing for flexible modular up/down-scaling. Such reconfigurable subsystems are controlled by a control system that is operable to select operational workflows from a workflow library, select particular operational configurations for reconfigurable workstations, and to adaptively control inventory storage of a modular storage system without requiring reprogramming of the control system based upon the current operational conditions and expectations. An exemplary method for multi-channel fulfillment includes a combination of fixed automation, flexible mobile automation, and modular process/control systems. Exemplary fixed automation includes automated storage and retrieval systems (AS/RS) and unit (i.e., single item) sortation systems (e.g., cross-belt sorter, and sorting mezzanines). Exemplary mobile automation includes bin transportation (e.g., bin-to-person AMRs), sortation inventory routing AMRs, and customer designated solutions (e.g., shelf-to-person AMRs). Exemplary modular process/control systems include a warehouse controller, control system, or orchestrator, a fulfillment control and monitoring system, a warehouse management system (WMS), a warehouse execution system (WES), and a supply chain management system.

An exemplary order-fulfillment facility or host facility's warehouse management system includes order information which is provided to the control system. As described herein, the control system controls the execution of orders (e.g., the aggregation and controlled release of orders (and the timing of those orders), allocation of inventory to fulfill the orders (including a consideration of reallocation of inventory to fulfill high priority orders)) for fulfillment within the facility. An exemplary order-fulfillment system includes a plurality of order channels. Each order channel may be defined according to its particular downstream resources and/or requirements. For example, the released order may be directed to picking items that are going to a “put wall” downstream, or for the picking of items put to a grid for a larger store or retail establishment. Other order channels include single-unit e-commerce, multi-unit e-commerce, retail/store, value added services (VAS), etc.

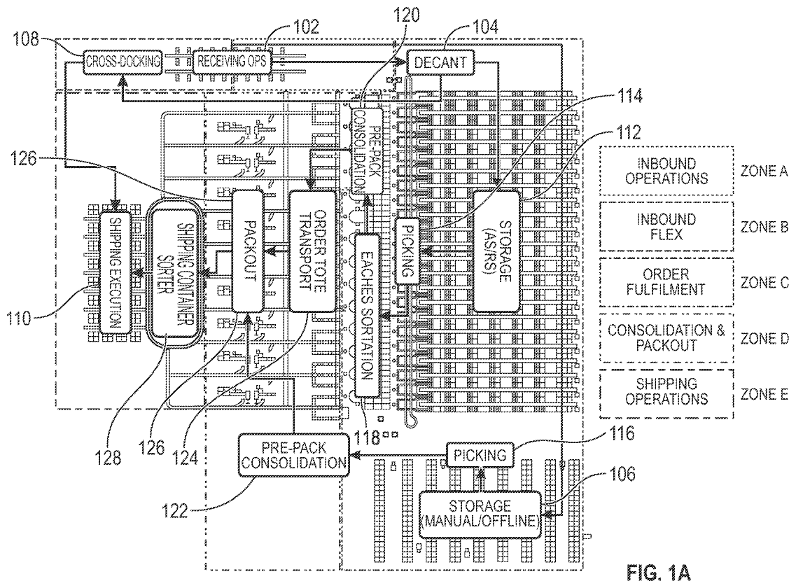

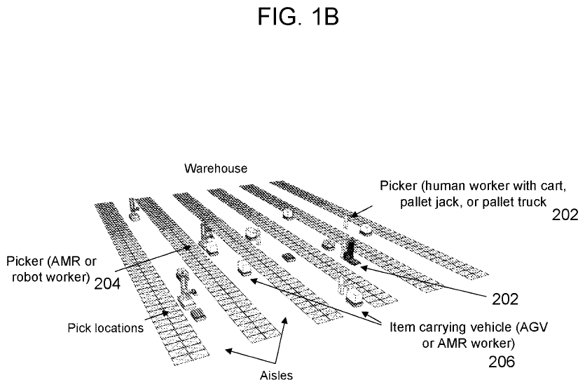

FIGS. 1A and 1B illustrate exemplary warehouse environments or aspects thereof in which order fulfillment activities are taking place. It should be appreciated that order fulfilment systems employing control systems in accordance with the present invention may be configured and employed in numerous ways and environments utilizing variously configured and differing material storage and handling systems. Accordingly, the below discussion of the systems of FIGS. 1A and 1B should be understood as non-limiting and provided for explanatory purposes.

With reference to FIG. 1A, an exemplary configurable warehouse or storage facility for order fulfilment is disclosed for use with control systems in accordance with aspects of the present invention. As illustrated, the order fulfilment facility includes an inbound operations zone A, an inbound flex zone B, an order fulfillment zone C, a consolidation and packout zone D, and a shipping operations zone E. The respective “zones” are defined/outlined in FIG. 1A with respective dashed lines. The inbound operations zone A comprises a receiving operations area 102 which is configured to deliver items to a package decant area 104 and an offline/manual storage area 106, which is part of the order fulfillment zone C. The inbound flex zone B comprises a cross-decking area 108 and the receiving operations area 102. As illustrated in FIG. 1A, the receiving operations area 102 is a part of both the inbound flex zone B and the inbound operations zone A. The cross-docking area 108 receives items from the receiving operations area 102 and delivers items to a shipping execution area 110 of the shipping operations area E.

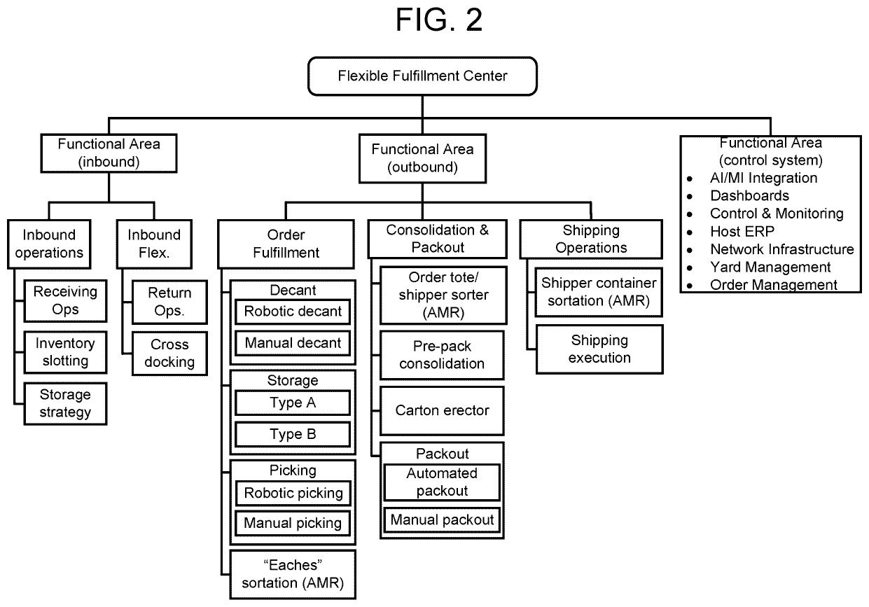

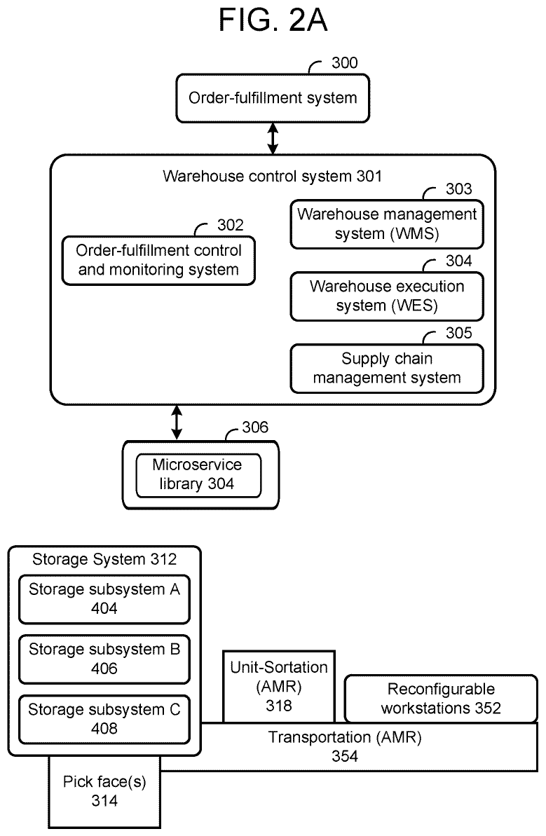

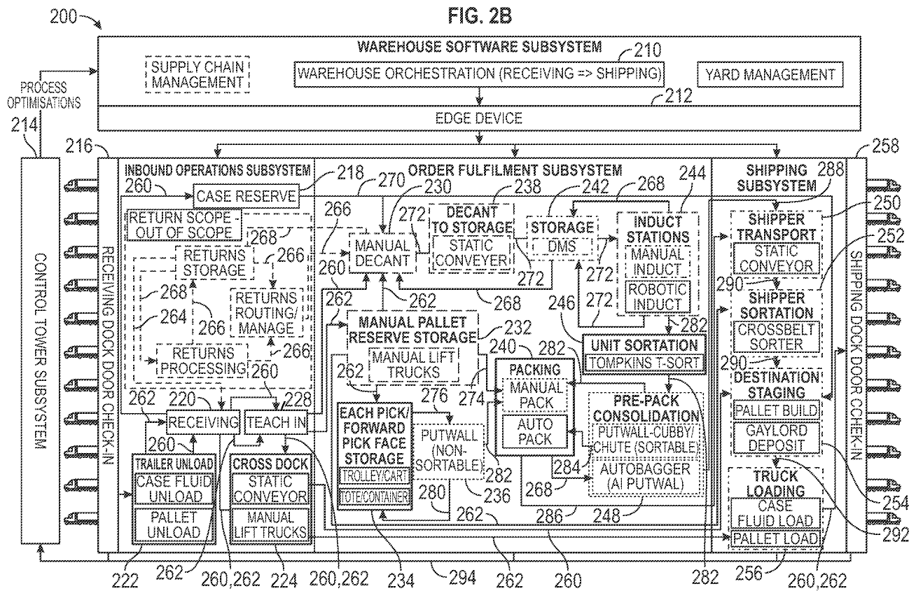

The order fulfillment zone C comprises an automated storage and retrieval (AS/RS) racking area 112 and the manual/offline storage area 106. The AS/RS racking area 112 and the manual/offline storage 106 are configured to store inventory items. As described herein, the inventory items are picked by picking areas 114, 116 from the AS/RS racking area 112 and the manual/offline storage 106, respectively, to fulfill orders. The order fulfillment zone C also comprises an “eaches” sortation area 118 for feeding items (e.g., individual items) from the picking area 114 to a pre-pack consolidation area 120. As illustrated in FIG. 1A, the picking area 116 is configured to deliver items to a pre-pack consolidation area 122. In one embodiment, the eaches sortation area 118 is also configurable to provide order line induction (e.g., multiple of the same SKU to sortation). FIG. 2B illustrates the distribution of eaches sorted (individually sorted) items 282 in the warehouse environment 200.

The consolidation and packout zone D comprises the pre-pack consolidation areas 120, 122 (which are considered part of both the consolidation and packout zone D and the order fulfillment zone C). While the pre-pack consolidation area 120 delivers items, such as in totes, to an order tote transport 124 for delivery to a packout area 126 where the items in totes are containerized, the pre-pack consolidation area 122 delivers items (in totes) directly to the packout area 126. Lastly, shipping operations zone E comprises a shipping container sorter 128 and the shipping execution area 110. The shipping container sorter 128 receives shipping containers from the packout area 126 and in turn sorts them and delivers the totes/containers of items to the shipping execution area 110.

With reference to FIG. 1B, an exemplary warehouse environment includes a variety of different agents 202, 204, 206. Each class of agents has distinct characteristics, objectives, and capabilities. The agents illustrated in FIG. 1B include human pickers 202, robotic pickers (which usually come in the form of autonomous mobile robots (AMRs) 204, and item carrying vehicles in the form of automated guided vehicles (AGVs) or autonomous mobile robots (AMRs) 206 configured to carry items picked by the human pickers 202 and/or the robotic pickers 204. Alternatively, the AGVs may be substituted with AMRs configured for carrying the picked items. The overall logistics of the warehouse would be distributed across the classes of agents 202, 204, 206. Additional agents would include fixed automation assets in the warehouse as well as fulfillment management systems (e.g., WES, WCS, and WMS). The agents 202, 204, 206 are allocated and/or assigned to one or more order channels within the warehouse (which are managed by the order-fulfillment system).

### Multi-Channel Fulfillment:

The exemplary multi-channel order-fulfillment system 300 is configured to meet a variety of customer order expectations (extensive product options, next day or same day delivery, simplified processes for returns and exchanges, and competitive pricing). Adding complications to the multi-channel fulfillment system 300, the above customer order expectations are expected to keep changing over time. That is, the best or most optimal way to fulfill an order at one point in time, such as today, may not be the best or most efficient way to fulfill an order at another point in time, such as tomorrow (or some day in the future), or even another time within the same day. Thus, the infrastructure technologies (and associated fulfillment control systems) used within an order-fulfillment system will change as warehouse/order fulfillment system technologies continue to change. It is also expected that customers will continue to change their buying habits and expectations, thus forcing companies to “keep up” in order to remain competitive.

Accordingly, because companies need the ability to quickly adapt their operations based on customer demands and expectations, their order-fulfillment systems will need the ability to change how tasks are completed within the respective order-fulfillment systems, as well as have the ability to seamlessly incorporate different technologies into their respective operations as the need dictates. In addition, the companies (and their fulfillment systems) need to leverage their data to gain better visibility into their operational performance, anticipate customer demands, and move towards a more autonomous, self-adapting, and self-healing supply chain. To achieve this reality, exemplary multi-channel order-fulfillment systems 300 require a powerful, reconfigurable supply chain control solution that provides configurable workflows that leverage (current) best in class distribution functionality. The exemplary multi-channel order-fulfillment system 300 optimizes and “orchestrates” work across any combination of humans and machines, and provides a wholistic view inside the facility, within surrounding regions, and across an entire supply chain that enables data-driven autonomous decision making.

Referring to FIGS. 1A, 2, and 2A, an exemplary multi-channel order-fulfillment system 300 comprises a control system 301 implemented with a variety of hardware and software that make up one or more computer systems or servers, such as operating in a network, comprising hardware and software, including one or more programs, such as cooperatively interoperating programs. For example, an exemplary embodiment can include hardware, such as, one or more controllers or processors configured to read and execute software programs. Such programs (and any associated data) can be stored and/or retrieved from one or more storage devices. The storage devices can be implemented as software-based, hardware-based, and/or hardware and software-based storage devices. The hardware can also include power supplies, network devices, communications devices, and input/output devices, such devices for communicating with local and remote resources and/or other computer systems. Such control system embodiments can include one or more computer systems and are optionally communicatively coupled to one or more additional computer systems that are local or remotely accessed. Certain computer components of the exemplary embodiments can be implemented with local resources and systems, remote or “cloud” based systems, or a combination of local and remote resources and systems. The software executed by the computer systems of the exemplary embodiments can include or access one or more algorithms for guiding or controlling the execution of computer implemented processes, e.g., within exemplary warehouse order fulfilment systems. As discussed herein, such algorithms define the order and coordination of process steps carried out by the exemplary embodiments. As also discussed herein, improvements and/or refinements to the algorithms will improve the operation of the process steps executed by the exemplary embodiments according to the updated algorithms. The order-fulfillment system's control system 301 as described may comprise a warehouse control system (WCS). As discussed herein, the control system 301 can include an order-fulfillment control and monitoring system 302, a warehouse management system (WMS) 303, a warehouse execution system 304, and a supply chain management system 305. While FIG. 2A illustrates components of the warehouse control system 301, such components can be grouped differently or implemented as separate components.

As illustrated in FIGS. 1A and 2, an exemplary multi-channel order-fulfillment system 300 comprises inbound and outbound functional areas controlled by associated process controls. The inbound functional area includes sub-systems (inbound operations and inbound flex) comprising material handling modules (e.g., receiving operations area, inventory slotting area, and storage strategy area; and return operations area; and cross docking area, respectively). The outbound functional area includes sub-systems, such as an order fulfillment area, consolidation and packout areas, and a shipping operations area. These sub-systems include material handling modules (e.g., a decant area (robotic and manual decant), an automated storage and retrieval systems (“AS/RS”) area (e.g., a Dematic Multishuttle® system (“DMS”), Autostore® warehousing systems, or the like)), picking functionality (e.g., robotic and manual picking), and “eaches” sortation (AMR based); an order tote/shipper sorter (AMR based), a pre-pack consolidation area, a carton erector area, and a packout area (automated and manual packout; and shipper container sortation (AMR based) and shipping execution, respectively.

FIG. 2B illustrates an alternative arrangement of components for a multi-channel order-fulfillment system operating within an exemplary warehouse environment 200. FIG. 2B illustrates an exemplary warehouse software subsystem in communication with a fulfillment control and monitoring system (e.g., control tower subsystem 214), an inbound operations subsystem, an order fulfillment subsystem, and a shipping subsystem (see also FIG. 1A). As illustrated in FIG. 2B, the warehouse software subsystem includes microservices associated to mechatronics modules implied with each module box. As discussed herein, the warehouse software subsystem receives process optimizations from the control tower subsystem 214 that are based upon data 294 collected from the various subsystems of the warehouse environment 200. The control tower subsystem 214 may be a cloud/on-premises enterprise network configuration, or other forms of off-premises or hybrid cloud network configuration. The inbound operations subsystem includes a receiving/dock door check-in 216, which is serviced by trailer unload 222 (which includes case fluid unloading and pallet unloading). Note that the receiving/dock door check-in 216 provides for dock door check-in of the trucks at respective dock doors for unloading. The unloaded pallets 262 and cases 260 (from trailer unload 222) are delivered to receiving 220, which delivers pallets/cases 262, 260 to a cross dock 224 (which includes static conveyor and manual lift trucks) and pallets 262 and cases 260 to a “teach in” 228. Note that receiving 220 also delivers cases 260 to a case reserve 218, which provides for a case storage area in the inbound operations subsystem. As described herein, case reserve 218 also provides full cases 270 to a manual decant 230 of the order fulfillment subsystem, as well as to a destination staging area 254 of the shipping subsystem. As illustrated in FIG. 2B, the cross dock 224 bypasses the order fulfillment subsystem and delivers pallets 262 (via manual lift trucks) and cases 260 (via a static conveyor) directly to a truck loading service 256 (which includes case fluid load and pallet load) and the destination staging area 254 within the shipping subsystem (respectively). FIG. 2B also illustrates the “teach in” 228 delivering cases 260 and pallets 262 to the manual decant 230 and the manual pallet reserve storage (with manual lift trucks) 232, respectively, within the order fulfillment subsystem. The case reserve 218 also delivers cases 260 to the manual decant 230.

As illustrated in FIG. 2B, manual decant 230 also receives mixed SKU totes 266 from a returns routing management, which receives mixed SKU totes 266 from a returns processing and a returns storage. The returns storage in the inbound operations subsystem receives mixed SKU totes 266 from the returns processing. The returns storage provides empty totes 268 to the returns processing and mixed SKU inventory 264 to the receiving 220.

Receiving cases 260 from the case reserve 218 and the “teach in” 228, and pallets 262 from the manual pallet reserve storage 232, the manual decant 230 fills totes 272 (that it receives from storage 242) as either pure or mixed SKU totes 272 and delivers them to a decant to storage 238 (which includes a static conveyor) for eventual delivery to storage 242 (which include a variety of storage means, e.g., DMS). The manual decant 230 receives empty totes 268, mixed SKU totes 266, and cases 260 and pallets 262. The storage 242 also sends and receives pure and mixed SKU 272 totes to/from induct stations 244 (which include manual induction and robotic induction). The induct stations 244 also pass empty totes 268 back to the storage 242. The induct stations 244 pass inventory items (e.g., eaches or individual item sortation 282) to unit sortation 246 (e.g., Tompkins T-Sort and other sortation systems), which passes the eaches sortation results 282 to a pre-pack consolidation 248. The manual pallet reserve storage 232 sends pallets 262 to the manual decant 230, to an “each pick/forward” pick face storage (which includes trolley/cart and tote/containers) 234, and to shipping sortation 252 (of the shipping subsystem). The each pick/forward pick face storage 234 delivers totes 276 (non-sorts via cart) to a putwall (non-sortable) 236 and receives empty carts/containers 280 in return. Both the putwall (non-sortable) 236 and the manual pallet reserve storage 232 deliver inventory to packing 240. The manual pallet reserve storage 232 delivers non-conveyable (non-sort) inventory 274 to packing 240, while the putwall (non-sortable) 236 delivers eaches sorted (individually sorted) items 282 to packing 240. The manual pallet reserve storage 232 and the putwall (non-sortable) 236 deliver their inventory to a manual pack of the packing 240. An auto pack of packing 240 receives order totes 284 from the pre-pack consolidation 248, while auto pack (of packing 240) delivers empty totes 268 to the pre-pack consolidation 248. Note that the pre-pack consolidation 248 also delivers eaches-sorted items 282 to the manual pack of packing 240.

The shipping subsystem includes a shipper transport (static conveyor) 250, a shipping sortation (crossbelt sorter) 252, a destination staging (pallet build and Gaylord deposit) 254, and truck loading (case fluid load and pallet load) 256. As illustrated in FIG. 2B, the shipper transport 250 receives auto packed or manual-packed orders 286 from packing 240 and autobagged orders 288 from the autobagger (at a putwall) of the pre-pack consolidation 248. The shipper transport 250 delivers packed orders 290 to the shipping sortation, which delivers the packed orders 290 to destination staging 254. The destination staging 254 also receives pallets 262 from the manual pallet reserve storage 232 and full cases 270 from the case reserve 218. The consolidated packed orders 292 are delivered by the destination staging 254 to truck loading 256. Truck loading 256 also receives cases 260 and pallets 262 from the cross dock (from static convey and manual lift trucks, respectively). Case fluid load and pallet load of the truck loading 256 receives the cases 260 and pallets 262, respectively. The truck loading 256 delivers the pallets 262 and cases 260 to shipping (dock door check-in) 258 for truck loading at the respective dock doors. Note that shipping dock 258 includes dock door check-in for those trucks received at shipping dock 258 for load (via the truck loading 256).

While many existing or conventional warehouse solutions could be categorized as “flexible, scalable, and modular,” such conventional warehouse solutions do not provide day-to-day operation at desired efficiency, while also allowing modularity of the fulfillment system in terms of being able to add new material handling modules/technologies to the fulfillment system either temporarily or seasonally to meet increasing/changing demands, and to downscale as needed to save costs when demands are not as high. The exemplary multi-channel fulfillment system is also configured to dynamically meet changing operational needs by adding or removing physical fulfillment infrastructure modules and modifying operational workflows without needing to involve technical resources and rewriting process control, and thereby maximizing productivity, throughput, and capacity at low cost. That is, additional fulfillment resources may be either added when the need is anticipated and then removed afterwards, or an existing surplus fulfillment resource that is temporarily added when needed and then deactivated afterwards. The physical placement and removal of fulfillment resources could be for anticipated large additional fulfillment needs (e.g., during expected holiday demand bursts), while the activation/deactivation of the surplus resources could be for short-term increases and decreases that occur more frequently (and less predictably). As used herein, “module” is used to describe a discrete component of physical infrastructure or of a process or function (e.g., the control system 301). That is, as discussed herein, while the control system 301 includes an architecture that is broken into interchangeable and reconfigurable components, the physical infrastructure of the order-fulfillment system 300 is also divided up into discrete components or modules. For example, multiple configurable workstations 352 can be reconfigured for particular order-fulfillment activities (and with their portion of the control system 301 corresponding to the particular microservices that control their operations added or updated to the control system 301). Thus, the multi-purpose workstations 352 are able to adapt processes as required.

The multi-channel fulfillment system 300 in accordance with aspects of the present invention enables the operational parameters of a given sub-system, such as a pick station, a put station, a decant station, or the like, to be altered so as to operate in another manner, such as reconfiguring operation of a pick station to a put station or the like, including by changing from human operation to robotic operation. Furthermore, such sub-systems can include, for example, reconfigurable workstations that may be selectively configured (and selectively reconfigured as needed) for any of a plurality of configurations, such as, order fulfillment operations, inventory induction, order packing, and the like. Such sub-systems can also include storage modules of a modular inventory storage system configured to store inventory items. Such storage modules can comprise one or more different storage techniques. The configuration of the modular inventory storage system can also include adding and/or removing additional storage modules in the modular storage system according to current and/or expected demands (e.g., daily versus weekly depends). Moreover, the control system is configured to monitor the order fulfillment requirements of the warehouse and manage the reconfiguration warehouse sub-systems to optimize the order fulfillment operations, with the control system correspondingly altering both the control of the particular sub-system through the selection of workflows from a library of workflows, and the selective configuration of reconfigurable workstations, and the configuration of storage modules of the modular storage system. Such selection of workflows, configurations of reconfigurable workstations, and configurations of storage modules of the modular storage system are executed by the warehouse control system without requiring additional programming or reprogramming.

The exemplary multi-channel fulfillment system 300 provides warehousing logistics operations including inbound operations, storage and inventory, order fulfillment operations and outbound operations as well as supply chain features, such as global inventory management and distributed order manage. The exemplary multi-channel fulfillment system and methods allow warehouse capacity and capabilities to scale and change flexibly over time to meet fluctuating and seasonal demands. It is characterized by quickly and easily being adaptable without having to customize or redesign, and therefore cost efficiently adapt as the operations. The exemplary multi-channel fulfillment system and methods also use real-time or near real-time data to intelligently orchestrate inventory and order flows in a warehouse/fulfilment center by controlling automated parts of the warehouse/fulfilment center and advising warehouse managers and operators (decision support) on current performance and how to configure workflows to maximize productivity, throughput, and capacity.

With references to FIGS. 2-4, exemplary embodiments of a multi-channel order-fulfillment system 300 avoid conventional “set in stone” features by avoiding a strictly defined facility layout and dynamic control process. Instead, an exemplary order-fulfillment system 300 comprises a plurality of reconfigurable solutions for controlling the order fulfillment, which includes reconfigurable infrastructure sub-systems and associated control systems with modular architecture. The multi-channel order-fulfillment system is able to scale up/down over a day/week/month time horizon in a dynamically adaptable fashion in (or near) real-time. An exemplary multi-channel fulfillment system 300 comprises a modular physical architecture with a centralized sortation system 318 connecting one or more generic storage types 404, 406, 408 (regardless of storage technology and/or technique) and associated pick faces 314 with manual and robotic multi-purpose workstations 352 (each configured to adapt their order-fulfillment processes and/or operations based on workflow changes) and a transportation system that uses AMRs 354 for transportation and buffering. As illustrated in FIG. 2A, an exemplary modular order fulfillment system 300 includes a dynamically reconfigurable warehouse controller, control system, or orchestrator 301, a fulfillment control and monitoring system 302, a warehouse management system (WMS) 303, a warehouse execution system (WES) 304, and a supply chain management system 305. The warehouse controller (control system) 301 is communicatively coupled to memory 306 that retains operational data 294 and a microservice library 304 (i.e., API library). Where memory 306 may comprise one or more hardware and/or software components, such as memory modules. In one embodiment the WMS 303 and the supply chain management system 305 are implemented as separate systems within the warehouse control system 301, alternatively, the WMS 303 can be a sub-component of the supply chain management system 305.

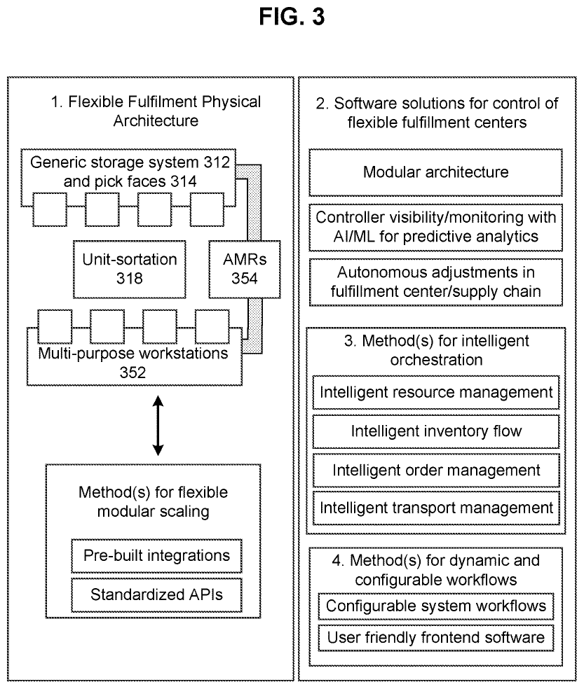

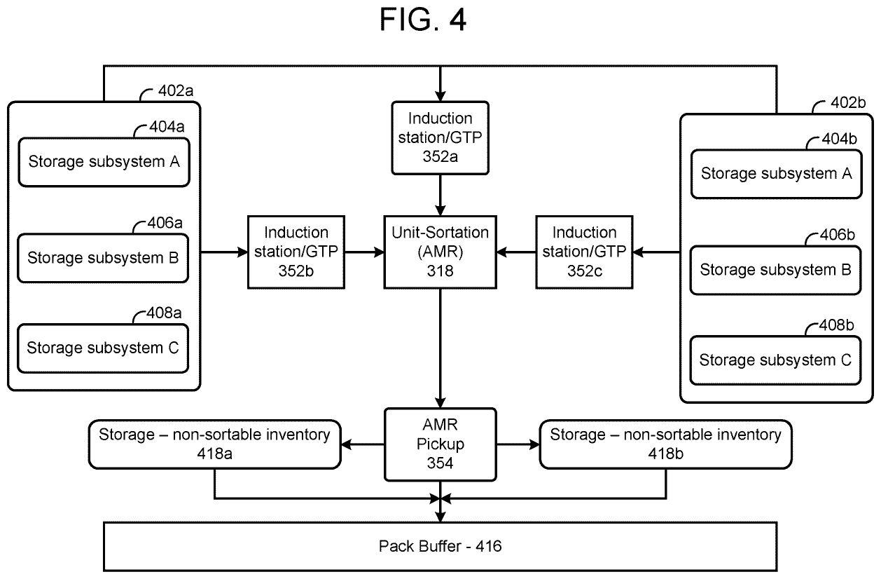

The exemplary centralized sortation system 318 (see FIGS. 3 and 4) is configured to receive inbound items from other subsystems, such as inventory storage locations, a receiving subsystem, a decant/induction subsystem, or the like. The sortation system 318 receives items and moves them to the correct “next” location. An exemplary sorter may be as described in commonly assigned U.S. Pat. No. 7,086,519, issued Aug. 8, 2006, which is hereby incorporated herein by reference in its entirety. As discussed herein, an exemplary sorter 318 may be configured as an extensive system of conveyors, etc., or may use AMRs. In one embodiment, the exemplary sort 318 may include cross-belt sorters, sorting mezzanines, and Bombay-style sorters.

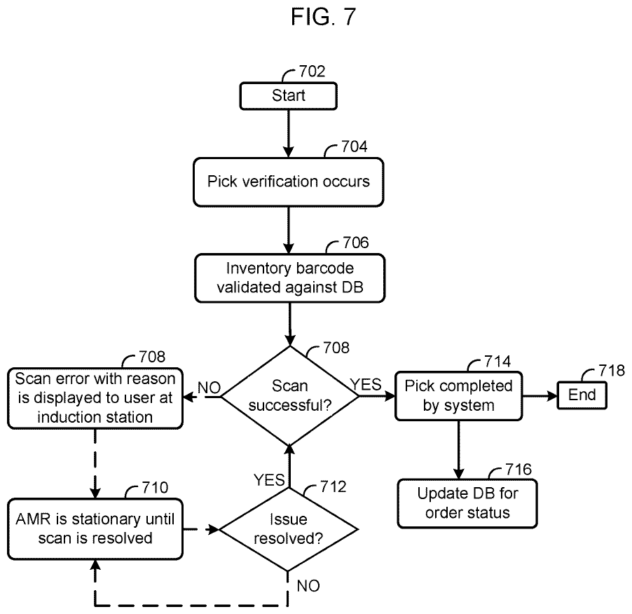

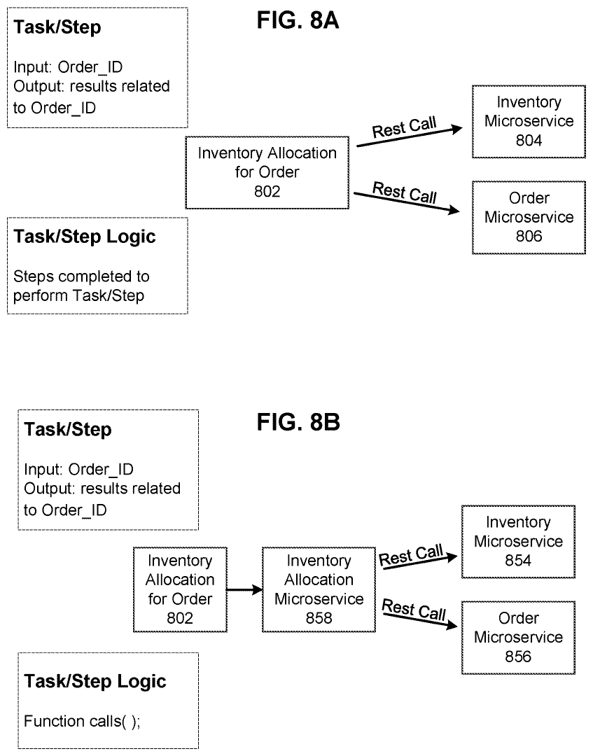

As illustrated in FIG. 2A, the multi-channel order-fulfillment system's exemplary control system 301 combines an order-fulfillment control and monitoring system 302 and traditional WMS 303, WES 304, and WCS 305 functionality into a single solution that allows for modular custom deployments that are tailored specifically to meet each customer's requirements, all while leveraging a standard and evolving toolkit of warehouse and supply chain functionality. The exemplary control system 301 utilizes standard warehouse and yard functions that execute all warehouse activities from receiving, storage, picking, sorting, packing, shipping, and inventory control. These warehouse and yard functions all exist as “microservices,” which as described herein, can be configured into customer-specific configurable workflows that are designed to meet the need of each customer (see FIGS. 8A and 8B). As used herein, a microservice is a “building block” or component of a software architecture that divides a program or application into components based upon the services those individual components (microservices) provide or perform. That is, a microservice is a component of an application that provides one or more services for the application. Each individual service within an exemplary microservice would be developed and maintained as a separate and discrete piece of software. Such arrangement allows a microservice (and its services) to be considered a “plug-n-play” component of a larger application or program (e.g., the control system 301). When there are multiple microservices (each with their own discrete services), these microservices can be interconnected together and communicate with each other via application programming interfaces (“APIs”). The advantage of a microservice architecture for the control system 301 is that additional (or updated) microservices can be easily created and added to the control system 301, without the need to rewrite code, thus cutting down on the amount of time and effort required to implement and adapt these workflows. Just as traditional WMS allowed for multiple ways to complete warehouse tasks (e.g., RF, voice, lights, paper), flexible fulfillment allows for the use of various fixed and flexible automation technologies and software solutions to be incorporated into a customer's configurable workflows.

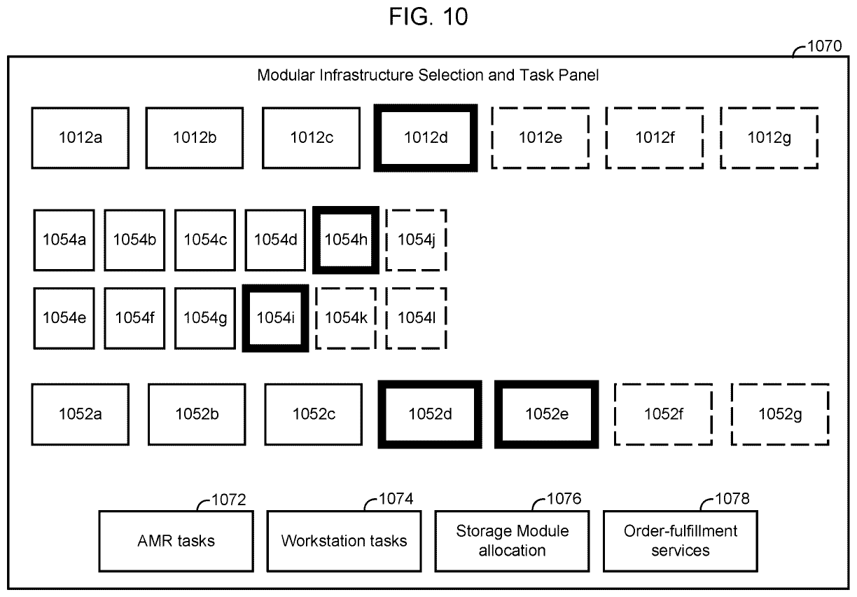

In one embodiment, an exemplary dynamic control process includes a process solution that controls the multi-channel order-fulfillment system. The dynamic control process is built with a modular architecture that includes a set of selected microservices from a library of microservices. The modular architecture of selectable microservices provides for maximized productivity, throughput, and capacity in the multi-channel fulfillment system. The dynamic control process comprises an intelligent orchestration or system control that uses an end-to-end inventory fulfillment logic to orchestrate (or control) the inventory and resources to efficiently fulfill customer orders. As described herein, the processes for dynamic and configurable workflows are built using a “drag-and-drop” or user-selection configuration via a user-friendly software interface which enables real-time configurable dashboards to inform warehouse managers and operators on warehouse conditions and exceptions, and to advise on root causes and recommended actions including recommended workflow configuration changes (see FIG. 10). The exemplary processes for flexible modular infrastructure component up/down-scaling is also based on “plug-and-play” infrastructure material handling components (e.g., reconfigurable workstations, a storage system that includes a plurality of inventory storage means without regard for their particular storage techniques, transportation means, and automation) available through a catalog of pre-built infrastructure integrations, and enabled through standardized microservices, such as found in an exemplary automation marketplace comprising a library of APIs (see FIG. 10). For example, one or more pick stations may be selectively added or removed, in which the pick station may be readily connected structurally as well as electronically in terms of controls, with the control system 301 including a software interface (comprising a selected set of microservices necessary to perform the needed services/functions of the pick station) configured to readily enable such pick stations to be added or removed without the necessity of programming.

As described herein, the exemplary fulfillment control and monitoring system provides monitoring and machine learning and artificial intelligence functionality for predictive analytics of the fulfillment process within the multi-channel order-fulfillment system, e.g., changes in operational performance, changes in order or item demand, and potential automation system maintenance issues. Thus, a customer's entire supply chain may be managed by managing global inventory across a customer's entire distribution network, including managing inventory positioning based on predicted customer demand as well as managing global customer orders and distributing orders to appropriate fulfillment centers to ensure customer commitments are met. For the fulfillment system to autonomously update configuration changes, adjust business rules, and adjust the allocation of resources within a fulfillment center or across the supply chain based on changing business conditions.

An exemplary multi-channel fulfillment system 300 with flexible architecture decouples the fulfillment workflows (executed by the warehouse control system 301) from technology and is capable of dynamically changing how orders are fulfilled in or near real-time based on customer demands and resource utilization (via intelligent orchestration at the warehouse control system 301) flexibly adapting capabilities over time (flexible module up/down-scaling).

With reference to FIGS. 2A, 3, and 4, an exemplary multi-channel fulfillment system 300 includes a flexible fulfilment physical architecture, a control system 301 configured to control execution within the multi-channel fulfillment center 300 and across the supply chain, processes for intelligent orchestration (at the warehouse control system 301), processes for dynamic and configurable workflows, and processes for flexible modular up/down-scaling via an automation marketplace of modular subsystems (physical inventory handling and storage subsystems and logical subsystems). An exemplary automation marketplace includes any one or more of the following: subsystems and configurations for materials handling, sorting, inventory storage, transportation, and reconfigurable workstations.

### Flexible Fulfillment Physical Architecture:

As illustrated in FIGS. 2A, 3, and 4, an exemplary flexible physical architecture for order fulfillment in a warehouse environment comprises: 1) a storage system 312 (with one or more generic storage types) and associated pick faces 314, 2) a unit sortation system 318, 3) multi-purpose workstations 352 that are able to adapt to different processes (e.g., decant/induction operations, order fulfillment operations, and packing operations; as well as configurations for human or robotic workers), and 4) AMRs 354 for transportation and buffering between the storage types 312/pick faces 314 and the multi-purpose workstations 352.

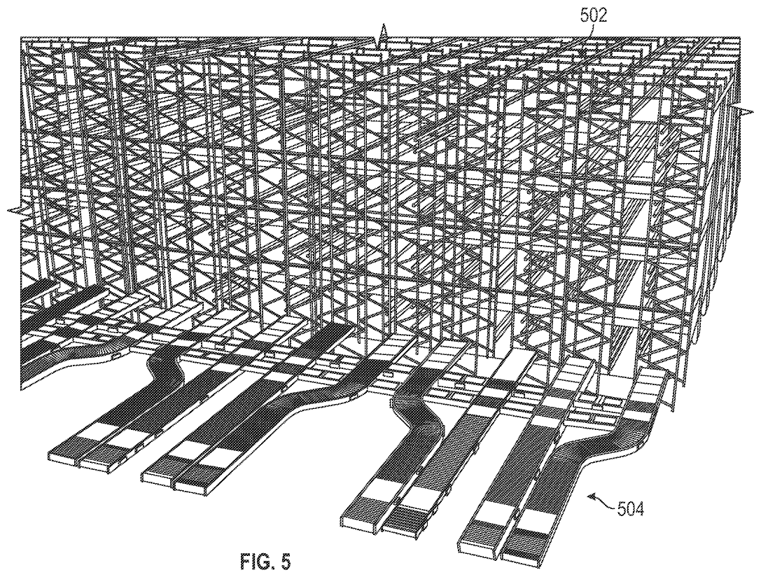

The multi-channel order-fulfillment system 300 may be configured in such a manner that a varying quantity of reconfigurable workstations 352 are configured and “activated” as necessary to meet throughput requirements in the warehouse facility. For example, a plurality of reconfigurable workstations 352 may be configured for any type of operation or service, e.g., a variable quantity of available workstations 352a-c may be configured for induction/decant operations, while another variable quantity of the available reconfigurable workstations 352 are configured for packing operations. It will be appreciated that due to the reconfigurable nature of the workstations 352 being capable of operating as any available configuration, various portions of the order-fulfillment system 300 (e.g., containing reconfigurable workstations 352) can be operated differently at different times of the day, as needed. The workstations 352 can be reconfigured substantially instantaneously as soon as all prior functions have completed. To increase flexibility, the reconfigurable workstations 352 are configured for human activities and/or robotic activities. The multi-channel fulfillment facility's control system 301 synchronizes various order-fulfillment functions and processes, including the sequencing of various sized shipping containers or pick totes (when in a picking or packing function) or various sized vendor cases or item containers (when in a decanting/induction function) with inventory/donor containers from, for example, an automated storage and retrieval system of the storage system 312 at a goods-to-person (GTP) or goods-to-robot (GTR) workstation to maximize productivity of the operations and throughput of the facility (see FIG. 5).

The multi-channel order-fulfillment system 300 includes a plurality of different inventory storage technologies and operations as segments (e.g., storage subsystem A 404, storage subsystem B 406, and storage subsystem C 408, where each subsystem is a different inventory storage technology) within an overall storage system 312. A common or modular architecture allows the storage system 312 with different units of measure (between the different storage subsystems) to be interchangeable and reconfigurable. In one embodiment, an exemplary storage system 312 is configured as a modular storage system comprising, for example, a pair of storage systems 402a, 402b, each including a set of storage subsystems 404a, 406a, and 408a; and 404b, 406b, and 408b, respectively. The storage system 312 includes automated and manual storage options that can be added or removed, whether individual storage units or additional shelves within a storage unit (e.g., non-sortable inventory storage 418a, 418b). Either adding/removing storage components to/from the storage system 312 or adding/removing storage modules to the storage system 312. For example, the storage types (of the storage system 312) and pick faces 314 can be automated storage and retrieval systems (AS/RS) with dense storage, high velocity storage types (AMR S2P (“shelf to person”)/B2P (“bin to person”)), or static shelf/manual pick (considered “low velocity,” reserve, and “non-totable”). The storage pick stations 314 can be goods-to-person or goods-to-robot and can handle both batch picking and induction to the sortation system. In one embodiment, the storage system 312 includes an AS/RS storage system where either portions of its storage capacity can be “deactivated” or shut down when the storage capacity exceeds the needed space. Alternatively, the AS/RS storage system could include storage modules that may be coupled as needed to the whole AS/RS storage system as need (and uncoupled (and optionally removed) when unneeded). Note that the unused portions of the AS/RS storage system or the unused storage modules will be empty, set to minimal or no power requirement and minimal to no maintenance requires to reduce operational overhead and costs. Note that the multi-channel order-fulfillment facility 300 includes storage systems 312 with pick faces 314 along portions of the storage system 312 that is immediately accessible to an order picker (e.g., human picker 202 and/or robot picker 204). Thus, as items are moved from a pick face, the storage system 312 will need to replenish the storage locations at the pick face 314 from other storage locations within the storage system 312. This transferal of items may be accomplished with AMRs 354 or other automated means. Note that additional inventory storage modules can be either added when the need is anticipated and then removed afterwards, or activated when needed and deactivated afterwards. The physical placement and removal of storage modules could be for anticipated large additional inventory storage needs (e.g., during expected holiday shopping bursts), while the activation/deactivation of storage modules could be for short term increases and decreases in demand.

The unit sortation system 318, illustrated in FIGS. 2A, 2B, 3, and 4, allows any unit picked from any pick medium to be transported for consolidation and/or packing to any pack-station. The unit sortation system 318 can be implemented as a centralized system, a decentralized system, or a distributed system. The unit sortation system 318 can be automated using an AMR solution and can sort to discrete multi-line order or multiple single-line order consolidation points. Circular, cross-belt, linear sorters, or Bombay-type sorters are commonly used for unit sortation. While an exemplary AMR-based unit sortation system is one exemplary embodiment, alternative embodiments can include crossbelt or Bombay-style sortations (complementing or replacing AMRs). FIGS. 3 and 4 illustrate a general overview of sortation with, for example, AS/RS storage. In one such arrangement an optimal layout may utilize a Dematic Multishuttle System (“DMS”) and the unique capabilities of DMS to “pre-sort” donor totes to DMS lifts. Such a system may be configured in accordance with U.S. Pat. No. 9,555,967, which is hereby incorporated herein by reference in its entirety.

Referring to FIG. 5, an exemplary AS/RS storage module 502 is associated with a material conveyance 504 for moving donor totes in and out of the AS/RS storage module 502. Note that while the conveyors 504 illustrated in FIG. 5 utilize conveyors and other similar means for inventory movement, AMR sort modules (e.g., the unit sortation (AMR) system 318) could also be used.

Exemplary AMRs for transportation and buffering are used through the flexible, modular order-fulfillment system 300 (see AMRs 354 of FIG. 3). The AMRs 354 are used for automated and flexible transportation throughout the order-fulfillment system 300. This allows for more even workflow distribution between pack stations (and the reconfigurable workstations 352) and helps to maximize throughput. The AMRs allow physical workflows to rapidly change without infrastructure changes. This allows the exemplary modular order-fulfillment system 300 to quickly scale up or down (in physical infrastructure). Such arrangements lead to greater sustainability through less energy usage versus traditional conveyance means or sortation.

An exemplary pack buffer 416 (see FIG. 4) de-couples packing stations and enables post-consolidation order sequencing. While induction stations are configured as workstations where product is placed onto sortation, pack stations are configured very simply (e.g., a simple workbench of sorts). The pack destination is not limited by conveyance and a predetermined path, providing the opportunity to redirect “ready-to-pack” orders to balance the workflow. Additionally, higher priority orders can bypass lower priority orders, prioritizing packing capacity and increasing on-time shipping probability compared to more fixed conveyor-based solutions.

### Example Workstation Processes

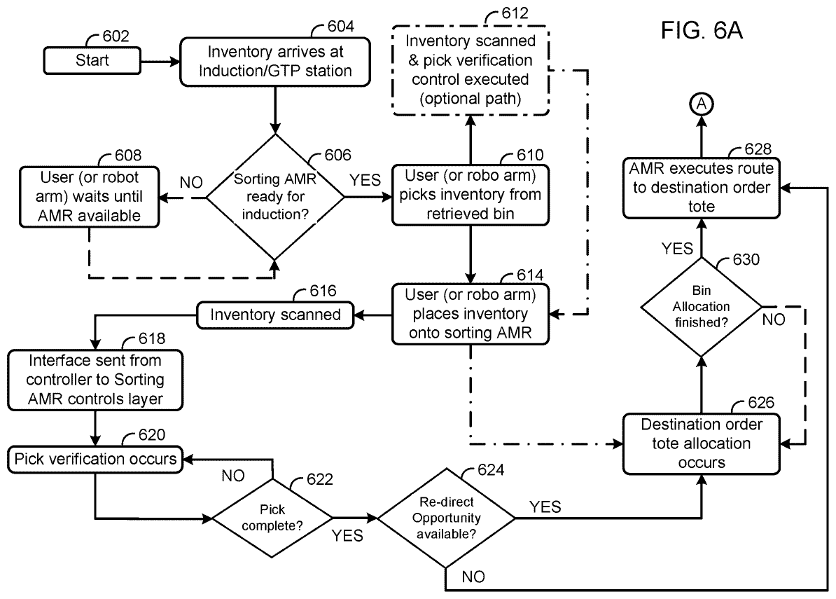

With reference to FIGS. 6A and 6B, an exemplary process for a goods-to-person (GTP)/induction workstation 352 is illustrated. Exemplary multi-purpose workstations 352 are configured to adapt processes based on workflow changes (e.g., induction, picking, packing, etc.). Manual and robotic/automated packing stations provide for interchangeability in fixed automation/mobile/human. As described herein, the exemplary packing stations allow for operation by both human and robot. Automated packing modules allow operations to progress to full automation over time without significant infrastructure changes. In one embodiment, exemplary packing modules are not physically connected to sortation or consolidation, enabling the adding of additional modules to increase order-processing capacity. Additionally, because any unit can arrive at any pack station, from any pick location, higher batch factors can be achieved in picking, increasing operational efficiency.

An operational process for an exemplary goods-to-person (GTP)/induction workstation 352 starts in step 602. In step 604, inventory arrives at the induction/(GTP) station 352. In step 606, a determination is made as to whether an AMR configured for sorting (a sorting AMR) is ready for induction (part of the unit sortation system 318). If the sorting AMR is not ready for induction, then the process proceeds with step 608, where the user (or robot arm) awaits until the AMR is available. When the sorting AMR is ready for induction, the process proceeds with step 610, where the user (or robot arm) picks inventory item(s) from a retrieved bin. Optionally, the process includes step 612, where the inventory item is scanned, and a pick verification control is executed. The process proceeds to step 614, where the user or robotic arm places inventory item(s) onto the sorting AMR. If step 612 has been performed, then after step 614, the process proceeds to step 626. If step 612 has not been performed, then the inventory is scanned in step 616. In step 618, an interface is sent from a fulfillment activities controller (e.g., warehouse control system 301) to a sorting controls layer (of the unit sortation system 318). In step 620, pick verification occurs. In step 622, a determination is made as to whether the pick is complete. If the pick is not complete, the process flow returns to step 620 and the pick verification reoccurs. If the pick is complete, the process proceeds to step 624, where a determination is made as to whether there is a re-direct opportunity available. If there is not, the process proceeds to step 628. If there is an opportunity for re-direction, then the process proceeds to step 626, where a destination order tote allocation occurs. In step 630, a determination is made as to whether the bin allocation is finished. If the bin allocation is not finished, the process returns to step 626, where the destination order tote allocation continues and then returns to step 630 for further processing. If the bin allocation is finished in step 630, the process proceeds on to step 628, where an AMR executes a route to a destination order tote. After step 628, the process proceeds to step 632 on FIG. 6B. In step 632, the AMR arrives at the destination order tote. In step 634, the AMR deposits the inventory item(s) into the destination order tote. In step 636, the database is updated for inventory location and order status. In step 638, a determination is made as to whether the order bin is complete. If the order bin is complete, then the process continues to step 640, where the interface is sent from the sorting controls layer (of the unit sortation system 318) for bin pickup. If the order bin is not complete (in step 638), then the process ends in step 642.

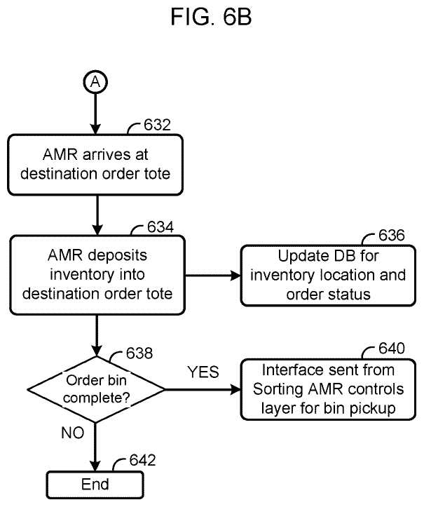

With reference to FIG. 7, the steps to an exemplary pick verification process are illustrated. In step 702, the pick verification process begins. In step 704, an exemplary pick verification occurs. In step 706, an inventory barcode is validated against a database. In step 708, a determination is made as to whether the scan was successful. If the scan was unsuccessful, the process proceeds to step 708 and a scan error with reason (for the error) is displayed to the user at the induction station. In step 710, the AMR is stationary until the scan is resolved. In step 712, a determination is made as to whether the issue is resolved. If the issue has not been resolved, the process returns to step 710 and the AMR remains stationary until the scan is resolved. In step 712, once the issue has been resolved, the process continues back to step 708, and the process again determines whether the scan was successful. If the scan was successful, then the process proceeds to step 714, where the pick is completed by the fulfillment system 300. In step 716 the database is updated for order status and in step 718, the process ends.

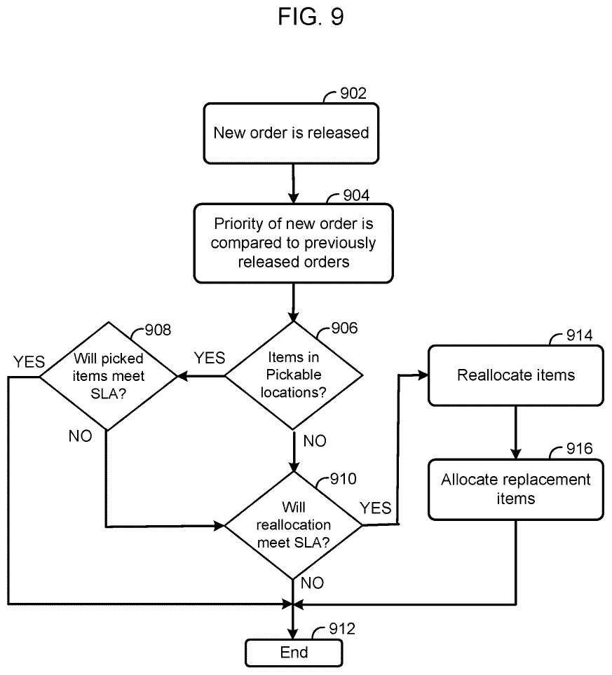

Referring to FIG. 9, an exemplary method for re-allocating already picked inventory (“pick stealing”) includes the following steps. In step 902, a new order is released. In step 904, the priority of the newly released order is compared to any previously released orders. In step 906, a determination is made as to whether there are inventory/items in pickable locations for the newly released order. If the inventory/items for the newly released order are in pickable locations, then the method proceeds to step 908. If there are inventory/items unavailable (i.e., not in pickable locations for the newly released order), then the method continues to step 910. In step 908, a determination is made as to whether the allocated inventory/items can be picked and meet the customer's service level agreement (“SLA”) for the newly released order. If the allocated inventory/items can be picked and meet the customer's SLA for the newly released order, then the method continues to step 912 and ends. If one or more of the allocated inventory/items cannot be picked and meet the customer's SLA for the newly released order, then the method proceeds to step 910. In step 910, a determination is made as to whether reallocating inventory/items from any previous orders with lower priorities would meet the customer's SLA for the newly released order. If reallocating inventory/items from the previous orders with lower priorities would not meet the customer's SLA for the newly released order, then the method ends at step 912. If reallocating inventory/items from the previous orders with lower priorities will meet the customer's SLA for the newly released order, then the method proceeds to step 914.

In step 914, the one or more inventory/items allocated to the previous orders with lower priorities are reallocated to the newly released order. In one embodiment, the inventory/items are only reallocated if there are additional inventory/items available to fulfill the lower priority order. In step 916, additional inventory/items are allocated to replace the one or more reallocated inventory/items to meet the customer SLA of the previous order(s) with lower priorities. The method ends at step 912.

### Intelligent Orchestration:

An exemplary controls system 301 for a multi-channel order-fulfillment system 300 comprises an end-to-end inventory-fulfilment logic based on intelligent orchestration of inventory and resources to fulfil customer orders (implemented in software). The exemplary fulfillment controls logic may be configured as a “facility orchestrator” (i.e., the warehouse control system 301) responsible for managing the overall flow of product and task execution throughout the order-fulfillment system 300. The orchestrator's main function is to ensure a consistent flow of work throughout the order-fulfillment system 300, avoiding bottlenecks (too much inventory for the available handling/processing resources) and starvations (too little inventory such that handling/processing resources may be idle). The orchestrator 301 decides what work needs to be completed, when it needs to be performed, and who (human) or what (machine) should perform the work. A warehouse (task) orchestrator 301 is responsible for prioritizing, optimizing, and orchestrating work amongst human workers and automation systems, ensuring a consistent flow of work throughout the warehouse and that the right work is getting completed at the right time in order to meet customer commitments. The orchestrator 301 automatically adjusts the flow of task execution based on different factors including order commitment times, inventory constraints, labor constraints and performance, and equipment performance. The orchestrator 301 continually evaluates what tasks need to be executed at what time and by who (human) or what (machine) in order to avoid bottlenecks and starvations and ensure customer commitment times are being met. The system maintains control of all fulfillable inventory from receiving through shipping. The system has the ability to route inventory for replenishment and fulfillment in real-time.

Functions performed by the orchestrator 301 include resource management and order management. When performing resource management, the orchestrator 301 monitors performance and utilization of resources (operators, mobile equipment, and robots), and redirects mobile resources as needed to avoid task bottlenecks or starvations. The order management includes sequencing order release at the proper time to meet customer service level agreements (“SLAs”) based on factors, such as, order fulfillment times, inventory constraints, and labor/machine capacity constraints. The orchestrator 301 may partition orders into different order-fulfillment subsystems as needed based on where the inventory is located and performance factors. The orchestrator 301 then ensures proper consolidation of those partial orders before shipping.

When performing order management, the orchestrator 301 is also able to perform intelligent release sequencing (units fulfilled from different storage subsystems (e.g., subsystems 404, 406, and 408) arrive simultaneously at consolidation point to avoid extended dwelling times. Individual units are released based on distance and pick rates, etc. Unit destinations are determined first at unit release and can be reallocated at induction to sortation (the sortation system 318) for multi-line orders. Single line orders may be re-allocated as far downstream as the pack station. The orchestrator 301 also performs intelligent flow adjustments, such as configurable order release and dynamic re-routing post-pick. Such flow adjustments are intended for waveless operation with multiple cut-off times and the fulfillment system can re-assign order unit destinations between picking and packing processes. For example, if 5:00 pm (1700 hours) is the cut off for priority orders, and it's now 9:00 pm (2100 hours) at night, the orchestrator 301 has the flexibility to immediately release all orders for 1700 anyway as they populate to allow for more priority orders to be serviced.

The orchestrator 301 includes a consolidation process capable of consolidating items into discrete orders (i.e., discrete order chute), batch orders (i.e., multi-order chutes), single item orders (i.e., multiple single line orders in one chute), polybag, and single item orders. Each point of consolidation (i.e., chute) can be configurable to any of the consolidated states and can be changed over the course of an operational period.

The orchestrator 301 also includes pick stealing (re-allocation) functionality (see FIG. 9). As higher priority orders are released, the order-fulfillment system 300 may be able to “steal” products/items that have been picked for another order and re-allocate them for the highest priority order. This may occur if stealing the pick is required to meet the customer's SLA of the higher priority order or if inventory does not exist in the pickable location for the higher priority order. After the pick steal occurs the system allocates additional inventory to satisfy the lower priority order. This behavior should be configurable by the customer. The customer should be able to configure whether pick stealing is allowed, up to what point in the fulfillment process an order is allowed to be stolen from, and whether pick stealing is allowed if no additional inventory is available to fulfill the lower priority order.

The orchestrator 301 manages inventory movement. The orchestrator 301 manages the flow of inventory across the order-fulfillment system 300 and manages movement of inventory to different areas of the warehouse/fulfillment facility as needed. For example, the orchestrator 301 determines and initiates replenishments into order fulfillment subsystems as needed to ensure proper inventory balancing. Such inventory management is based on predicting customer behavior and handling SKU proliferation. It uses historic as well as current information to direct inventory put away and replenishment. Such inventory movement also includes transportation management where the orchestrator 301 issues instructions to fixed and flexible automation systems for the movement of goods.

Lastly, the warehouse task/control orchestrator 301 leverages control & monitoring functionality (via the order-fulfillment control & monitoring system 302) to monitor operations from the “four walls” of warehouse to the entire enterprise, providing insights into operation performance, alerting to process exceptions, and identifying performance degradation due to changes in labor, equipment, order profile, etc. Advanced data integration and guided workflow resolution capabilities allow the system to identify root causes of issues and provide recommendations of how to resolve issues and exceptions. The system is able to be configured to adapt system configurations autonomously or allow a human to make configuration changes. Additionally, the control/monitoring system's AI/ML capabilities (with respect to control system visibility/monitoring) are used to provide predictive analytics to forecast future changes to the customer distribution network and environment (e.g., higher demand for specific SKU's due to weather, supply chain issues, transportation delays, etc.).

### Dynamic and Configurable Workflows and Microservices:

Controlling order fulfillment within an exemplary multi-channel order-fulfillment system 300 and across its associated supply chain includes a control system 301 (software solutions to control the execution within flexible fulfilment centers and across the supply chain) with a modular architecture that is built upon a foundation of microservices. Using microservices, the control system 301 is configured to control the order-fulfillment system 300 and to guide human workers in the warehouse facility. The exemplary control system 301 uses real-time or near real-time data to intelligently orchestrate inventory and order flows in the warehouse/fulfillment facility by controlling automated parts of the warehouse/fulfillment facility and advising warehouse managers and operators (decision support) on current performance and how to configure workflows to maximize productivity, throughput, and capacity. The control system 301 allows for opportunistically fulfilling order demand from inventory being received into the facility. Such cross dock-like functionality allows for the most efficient order fulfillment, completely bypassing storage.

The exemplary modular order-fulfillment system 300 allows for non-linear flows and decision-making, i.e., each location where an inventory unit is scanned or identified, it should opportunistically choose the next best location (sending the unit to either storage or fulfillment). A continuously updating optimization calculation using real-time data to optimize flow throughout the solution. This flexibility enables for more efficient picking upstream, combining singles and multi-pick missions; more flexible workflow to packing stations to mitigate capacity loss due to starvation; eliminate singles packing dependency and allow the operation to adapt to drastic changes in order profile (i.e., singles percentage of backlog) without moving labor.

Microservices consist of groupings of one or more code functions or services that can run as standalone services and can be easily coupled together with other microservices to build specific solutions (via APIs coupling the microservices together). Microservices contain code that execute specific functions and/or services (e.g., picking, receiving, etc.), control user interface screens, handle integrations to other systems and solutions, and process background functions (e.g., message processing, alerting, etc.).

Multiple instances of a microservice can be created and run at the same time to ensure proper system performance. For example, a single instance of a microservice may be used to process activity at goods-to-person (GTP) workstations 352. During peak hours, additional GTP workstations 352 may come online causing an increase in the amount of processing that needs to occur. In response to the additional GTP workstations 352, the system may create additional instances of the GTP workstation microservice. When volumes drop, the additional microservices are removed. Additionally, when no GTP processing is taking place all instances of the GTP workstation microservice may be removed to ensure the system is running as lean as possible to maximize system performance. It is also important that when multiple instances of a microservice are created that task sequencing is considered. For example, having multiple instances of a microservice that is used to process messages from a conveyor may cause messages to be processed out of order.

Developing a controls architecture using microservices allows a complex control system (i.e., the warehouse control system 301) to be broken down into smaller, simpler, and more manageable parts. Building the control system 301 this way allows for the following benefits:
Separation of functionality into appropriate subsystems/control modules to avoid a monolithic approach.
Improved patching and upgradability by decoupling functionality and use of defined APIs between subsystems/modules to allow for independent deployment without impacting overall system functionality.
Support for improved testing of functionality.
Increased speed of development.
Microservices help on elasticity and resilience of the system, by growing the number of instances when demand increases and reducing them when no longer needed.

The exemplary control system 301 for a multi-channel order-fulfillment system 300 comprises a frontend interface for workflow configurations. The control system 301 is fed and advised by real-time and historic data (from the order-fulfillment control & monitoring system 302) for constant optimization. The interface is configured to inform warehouse managers and operators on conditions and to advise on action, with the ability to flexibly reconfigure warehouse workflows. Embodiments of the multi-channel order-fulfillment system 300 allows for fully configurable system workflows. For example, particular order-fulfillment systems 300 are able to tailor all system workflows by connecting different tasks to match the operational requirements of the warehouse facility. The exemplary control system 301 provides default configurations for different workflows and workflow activities.

The control system 301 uses workflows that are used to define how human operators and machines complete warehouse tasks and are also used to determine how products/inventory items should flow through the warehouse/fulfillment facility. Configuration of workflows may be done using a “no code/low-code” workflow editor (see herein). This approach to workflow configuration allows a particular multi-channel order-fulfillment system 300 to have custom workflows that meet their needs but are built with standard functionality. This approach also cuts down on the time, effort, and cost required to implement and adapt the multi-channel order-fulfillment system 300 since the configuration can be done without the need to write code.

In addition to the ability to configure the different workflows, configurations exist within the tasks that make up the workflows that allow individual customers to tailor exactly how the tasks behave (within their warehouse/fulfillment centers). These configurations are able to be performed without the need to write code. Examples of task configurations include, for example, rules for item storage, rules for inventory selection at order allocation, what information a user needs to capture at picking, whether product can be over-received against a PO, and the movement paths product takes through the warehouse during the order fulfillment process. All configuration changes are to be logged by the order-fulfillment system 300 indicating when the parameter was changed to allow for traceability to changes that might impact system performance. Where allowed by the customer and local/regional laws, the user that performed the change is also logged. In one embodiment, the control system 301 is “cloud based” and provides instructions and information. Such as, where to send workers, predicts capacity based on current information (in the warehouse/fulfillment center), alerts for operational risk, and suggests actions.

Workflows consist of a series of tasks (or steps) required to complete the workflow in which data is updated and transferred. Tasks can be designed to be performed by a specific type of machine or by a human. Tasks contain code that executes when a task is performed. The code consists of either a single microservice or a set of microservices that are designed to work together. For example, in an order identification task, an Order_ID is input to allocate inventory. In response, a corresponding output includes, for example, a list of inventory reservations for that order (location, SKU, quantity reserved); the original order is modified where lines extended with the location to do the pick from; and a return status (i.e., success or failure). The task/step logic includes those steps to be carried out in accordance with the microservice task (e.g., for the Order_ID task, for each order line, available inventory is found for that order line; the order line is updated with the location where the inventory is found; and an inventory reservation is created for that specific order). FIG. 8A illustrates an example of a task 802 that allocates inventory for an order. This task 802 consists of two microservices 804, 806. Both of the microservices 804, 806 call two code functions. For example, inventory microservice 804 calls exemplary operations [Inv_Info Get_Available_Inventory_for_SKU(SKU)] and [Inv_Res Create_Inventory_Reservation (Loc,sku,qty,order)], while inventory microservice 806 calls exemplary operations [Order_Get_Order_by_ID (Order_ID)] and [Void Update_Order_Line (OrderLine line)]. Each time this task is performed, these two microservices 804, 806 (and their operations) will be executed. As illustrated in FIG. 8A, when an order ID is received by the control system 301, the exemplary workflow's first task or step logic outputs a list of inventory reservations for that order (location, SKU, and quantity reserved), modifies the original order to extend the lines with location(s) to do the pick from, and returns a status (success/failure). The workflow's second task or step includes finding available inventory for each order line's SKU, updating the order line with the location where the inventory is found, and creating an inventory reservation for that specific order. As illustrated in FIG. 8A, when the inventory allocation task 802 is called by the input of the order ID, a pair of microservices 804, 806 (i.e., an inventory microservice 804 and an order microservice 806) are called to execute the workflow. As noted above, each microservice 804, 806 includes a pair of code functions. The operations of the inventory microservice 804 include call functions for acquiring the information concerning the location, SKU, quantity, etc. of the order and reserving the inventory items for the order.

Meanwhile, the operations of the order microservice 806 include call functions for calling the particular order according to its order ID and updating the order lines of the called order (with the location where inventory found). As discussed herein (and illustrated in FIG. 2A), the microservices 804, 806 used to execute the workflow are selected from a library 304 of available microservices (e.g., a library of available APIs that can be used to build a desired function).

As illustrated in FIG. 8B, microservices can be grouped together in a “wrapper microservice” 858. Tasks 802 can execute these wrapper microservices 858 and, when executed, the wrapper microservice 858 will execute its sub-microservices 854, 856. This approach (wrapper microservices) allows for often-used functions that consist of multiple microservices to be easily inserted into tasks without having to recreate the function each time and allows for streamlined updates to microservices, as sub-microservices (in the microservices library 304) can be updated, which in turn updates all associated wrapper microservices.

The wrapper microservice 858 of FIG. 8B, similar to the task 802 of FIG. 8A, includes an example of a task 802 that allocates inventory for an order by calling the wrapper microservice 858. As discussed with respect to FIG. 8A above, in an exemplary order identification task, an Order_ID is input to allocate inventory. In response, a corresponding output includes, for example, a list of inventory reservations for that order (location, SKU, quantity reserved); the original order is modified where lines extended with the location to do the pick from; and a return status (i.e., success or failure). The task/step logic includes those steps to be carried out in accordance with the microservice task (e.g., for the Order_ID task, for each order line, available inventory is found for that order line; the order line is updated with the location where the inventory is found; and an inventory reservation is created for that specific order). In a similar fashion, the task/step logic includes those function calls for the steps to be completed (call inventory; allocation of microservice function to perform the task to perform the task/step). This task 802 consists of a wrapper microservice 858 (an inventory allocation microservice) that calls a pair of sub-microservices (an inventory sub-microservice 854 and an order sub-microservice 856). Similar to those seen in FIG. 8A, each of the two sub-microservices 854, 856 calls a pair of code functions. For example, inventory microservice 854 calls exemplary operations [Inv_Info Get_Available_Inventory_for_SKU(SKU)] and [Inv_Res Create_Inventory_Reservation (Loc,sku,qty,order)], while inventory microservice 856 calls exemplary operations [Order_Get_Order_by_ID(Order_ID)] and [Void Update_Order_Line (OrderLine line)]. The inventory sub-microservice 854 includes call functions for acquiring an inventory (by SKU) for the order, and creating an inventory reservation (location, SKU, and quantity reserved for the order). Meanwhile, the order sub-microservice 856 includes call functions for calling the particular order according to its order ID and updating the order lines of the called order (with the location where inventory found). As also discussed above, the sub-microservices 854, 856 can be selected from a library 304 of available sub-microservices.

### Flexible Modular Up/Down-Scaling (Via Automation Marketplace):

An exemplary multi-channel order-fulfillment system 300 is flexibly scalable up and down using “plug-and-play” modules providing additional storage, configurable workstations, AMRs, and point solutions for additional workflows. Thus, additional capacity can be added with little, or no infrastructure changes required. To account for the large amount of potential automation solutions that a customer may want to incorporate into its fulfillment operations, exemplary embodiments provide an “automaton marketplace” consisting of pre-built integrations to numerous automation solutions (both hardware and software solutions) that can be enabled and added into a configurable workflow. Such pre-built integrations can be implemented as “plug-and-play” modules.

These pre-built integrations (plug-and-play modules) can exist for many types of automation and software systems (see FIGS. 3 and 4), including, but not limited to:
Modular storage—automated or manual storage options that may be added or removed over time (full systems or additional shelves).
AMRs/AGVs for transportation and buffering.
Picking workstations (robotic and manual), which could be separate or combined with sortation induction stations.
Packing workstations (robotic and manual) including auto packing equipment
Parcel shipping solutions.
Automation islands that include interchangeability in fixed automation/mobile/human.

Flexibility is enabled through standardized microservices for subsystems allowing scalability and interchangeability, i.e., simplified and repeatable integration of any subsystem into the solution without requiring custom integrations (avoiding dependencies, reprogramming). That flexibility is further enhanced by providing a marketplace of pre-built integrations to various automation and software solutions, the effort, time, and cost of implementation is significantly decreased as there is no need to write code every time any flexible fulfillment facility wants to add a new automation solution. This approach also ensures standardization of interfaces across all customers' fulfillment facilities which simplifies the ongoing maintenance of the integrations and decreases the overall support effort.

Referring to FIG. 10, an exemplary modular infrastructure selection and task panel 1070 is illustrated. In one embodiment, the panel 1070 functions as a selection and task allocation panel accessed by an operator or manager for selection of infrastructure components and their functional task/service selection (as needed for order-fulfillment). In another embodiment, the panel 1070 functions as a selection and task monitoring/indicator panel illustrating the control system's dynamic selection and reconfiguration of infrastructure components needed for order-fulfillment based upon current warehouse order-fulfillment activities (as provided by the order-fulfillment control and monitoring system 302). That is, the selection of configurations (or reconfigurations) of individual workstations, storage modules of a modular storage system, and/or the selection of workflows from a library of workflows for current or anticipated warehouse operations, may be either performed by user interaction with the selection and task allocation panel 1070 or performed dynamically by the control system 301 (with the panel 1070 functioning as a selection and task monitoring/indicator panel).

FIG. 10 illustrates the allocation, configuration, and status of warehouse sub-systems, such as, storage modules of a storage system 312, AMRs 354, and workstations 352. As illustrated in FIG. 10, the status of a set of storage modules 312 is illustrated by an array of graphical buttons 1012a-g. The storage modules 312 represented by graphical buttons 1012a-c are depicted as currently allocated and storing inventory. The storage module 312 represented by graphical button 1012d is depicted as currently selected for allocation, while the storage modules 312 represented by graphical buttons 1012e-g are depicted as deactivated. When the graphical button 1012d was selected for allocation (of the corresponding storage module 312), the graphical button 1076 was also selected to provide an indication of the type of storage module allocated (e.g., component of an ASRS storage system, or the like).

The graphical buttons 1054a-g of FIG. 10 depict AMRs 354 allocated for transportation and/or sorting duties (and other assignments). Graphical buttons 1054h-i depict AMRs 354 that have been selected for allocation and tasking, while graphical buttons 1054j-l depict AMRs 354 that are currently deactivated and awaiting allocation. When the graphical buttons 1054h-i were selected for allocation (of the corresponding AMRs 354), the graphical button 1072 was also selected to provide an indication of the type of service and/or function that the allocated AMRs 354 are being configured to perform. The graphical button 1072 can also be used to select or indicate the type of AMR in question.

In a similar fashion, the graphical buttons 1052a-c of FIG. 10 depict configurable workstations 352 allocated for order fulfillment duties. The graphical button 1072 indicates the type of functional tasks/services the allocated AMR 354 performs (or is to perform), while the graphical button 1074 indicates the type of functional task/service that the allocated workstation is configured to perform (or will be configured to perform). Graphical buttons 1052d-e depict configurable workstations 352 that have been selected for allocation and tasking, while graphical buttons 1052f-g depict configurable workstations 352 that are currently deactivated and awaiting allocation. When the graphical buttons 1052d-e were selected for allocation (of the corresponding configurable workstations 352), the graphical button 1074 was also selected to provide an indication of the type of service and/or function that the allocated configurable workstations 352 are being configured to perform. The graphical button 1074 can also be used to select or indicate the type of AMR in questions.

In addition to the AMR task selection panel 1072, the workstation functional task/service selection panel 1074, and the storage module allocation panel 1076, an additional panel 1078 is used indicate or select additional order-fulfillment services that the infrastructure components are performing.

In one embodiment, those infrastructure components (312, 354, 352) that are indicated as deactivated and awaiting allocation are currently sitting in the local warehouse facility and awaiting allocation and configuration. In another embodiment, an additional graphical button could be used to indicate that storage modules 312, AMRs 354, and/or configurable workstations 352 have been ordered and are expected to be delivered to the warehouse environment and activated in due course. The panel 1078 may also be used to indicate the time frame for delivery of the requested infrastructure components.

Accordingly, the exemplary multi-channel order-fulfillment system 300 includes scalability to meet fluctuating and seasonal demands, and they handle average to peak volumes. The flexibility is able to change over time, adapt cost efficiently and fast as the fulfillment operations grow or business needs change. With modular components and an adaptable control system (facility orchestrator) 301, an exemplary order-fulfillment system 300 may be flexibly managed and monitored (e.g., real-time data can be provided to advise operators and managers of current performance). Thus, the multi-channel order-fulfillment system 300 can quickly and easily adapt without having to customize or redesign. Easy integration of flexible automation allows for quick scaling (up or down). Fully automated modules may be used to (gradually) replace human operators to reduce labor dependency. The resulting multi-channel order-fulfillment system 300 is not dependent on a specific unit of measure or workflow and allows non-linear workflows. The exemplary fulfillment facility's flexibility meets changing operational needs and thereby maximizes productivity, throughput, and capacity at low cost. Workflows are adaptable to handle dynamic operational needs and requirements as they occur. Dynamic resequencing of units is also possible to meet ever changing order backlog priority changes. Customers (fulfillment facilities) are allowed to build and modify operation workflows without needing to involve technical resources and without writing code to change (their workflows) using microservices (e.g., APIs) selected by the customer from a library of available microservices.

Changes and modifications in the specifically described embodiments can be carried out without departing from the principles of the present invention which is intended to be limited only by the scope of the appended claims, as interpreted according to the principles of patent law including the doctrine of equivalents.

1. An order-fulfillment system for a warehouse, the order-fulfillment system comprising:
a control system configured to control fulfillment activities of the warehouse and record operational data corresponding to the fulfillment activities in the warehouse;
a memory configured to store the operational data and a workflow library;
a modular inventory storage system configured to store inventory items, and reconfigurable workstations configured to operate in one of a plurality of operational configurations;
wherein the control system is operable to select an operational configuration for each of the reconfigurable workstations;
wherein the control system comprises a plurality of workflows selected from the workflow library, the workflows defining how the control system controls the fulfillment activities in the warehouse; and
wherein the selected workflows, the selected operational configurations for the reconfigurable workstations, and a configuration of the modular inventory storage system correspond to a current state of the warehouse defined by selected portions of the operational data.

2. The order-fulfillment system of claim 1 further comprising a sortation system that comprises a plurality of autonomous mobile robots (AMRs), each configured to move inventory items from one location to a desired next location.

3. The order-fulfillment system of claim 2, wherein the sortation system is a unit sortation system.

4. The order-fulfillment system of claim 1, wherein the modular inventory storage system comprises one or more different storage techniques.

5. The order-fulfillment system of claim 4, wherein the configuration of the modular inventory storage system comprises adding/removing additional storage modules to the modular inventory storage system according to current and/or expected demands.

6. The order-fulfillment system of claim 4, wherein the configuration of the modular inventory storage system comprises adding/removing additional storage capacity to a module of the modular inventory storage system according to current and/or expected demands.

7. The order-fulfillment system of claim 1, wherein a workflow comprises one or more function calls, with each function call a microservice selected from a library of microservices.

8. The order-fulfillment system of claim 7, wherein the microservices comprise wrapper microservices, each comprising sub-microservices selected from a library of sub-microservices.

9. The order-fulfillment system of claim 1, wherein the reconfigurable workstations are configured for use by humans and/or robots.

10. The order-fulfillment system of claim 1, wherein the control system is operable to determine or identify a priority level of a newly received order, and wherein the control system is further operable to determine whether inventory allocated for one or more previously received orders is reallocated to the newly received order if necessary to meet the newly received order's service level agreement (SLA) if the newly received order has a priority level higher than the previously received orders.

11. The order-fulfillment system of claim 1, wherein the operational configurations for the reconfigurable workstations comprise order fulfillment operations, inventory induction, or order packing.

12. A method for controlling order-fulfillment activities in a warehouse, the method comprising:
controlling fulfillment activities in the warehouse;
selecting particular operational configurations from a plurality of configurations for each of a plurality of reconfigurable workstations;
controlling and configuring a modular inventory storage system;
recording operational data corresponding to the fulfillment activities in the warehouse, wherein the operational data is stored in a memory;
wherein the control of the fulfillment activities in the warehouse and the configuration of storage systems are defined by a plurality of selected workflows that are selected from a workflow library stored in the memory; and
wherein the selection of workflows, the selection of the operational configurations for each of the plurality of reconfigurable workstations, and the configuration of the modular inventory storage system correspond to a current state of the warehouse defined by selected portions of the operational data and expected demands.

13. The method of claim 12 further comprising controlling a sortation system by controlling a plurality of autonomous mobile robots (AMRs), each configured to move inventory items from one location to a desired next location.

14. The method of claim 13, wherein the sortation system is a unit sortation system.

15. The method of claim 12, wherein the modular inventory storage system comprises one or more different storage techniques.

16. The method of claim 15, wherein configuring the modular inventory storage system comprises adding/removing additional storage modules to the modular inventory storage system according to current and/or expected demands.

17. The method of claim 15, wherein configuring the modular inventory storage system comprises adding/removing additional storage capacity to a module of the modular inventory storage system according to current and/or expected demands.

18. The method of claim 12, wherein a workflow comprises one or more function calls, with each function call a microservice.

19. The method of claim 18, wherein the microservices comprise wrapper microservices, each comprising sub-microservices selected from a library of sub-microservices.

20. The method of claim 12, wherein the reconfigurable workstations are configured for use by humans and/or robots.

21. The method of claim 12 further comprising determining or identifying a priority level of a newly received order and determining whether inventory allocated for one or more previously received orders is reallocated to the newly received order if necessary to meet the newly received order's service level agreement (SLA) if the newly received order has a priority level higher than the previously received orders.

22. The method of claim 12, wherein the operational configurations for the reconfigurable workstations comprise order fulfillment operations, inventory induction, or order packing.
